(19) United States
(12) Patent Application Publication
(10) Pub. No.: US 2017/0027366 A1
(43) Pub. Date: Feb. 2, 2017

(54) PORTABLE MULTILEVEL RACK AND ENCLOSURE ASSEMBLY FOR MICROWAVE OVENS

(71) Applicant: Kameron Scott Wilson, Spring Valley, CA (US)

(72) Inventor: Kameron Scott Wilson, Spring Valley, CA (US)

(21) Appl. No.: 15/199,767

(22) Filed: Jun. 30, 2016

Related U.S. Application Data
(60) Provisional application No. 62/187,229, filed on Jun. 30, 2015.

(51) Int. Cl. A47J 27/13; A47J 36/06

(52) U.S. Cl. CPC A47J 27/13; A47J 36/06

(57) ABSTRACT

The disclosed embodiments relate to an apparatus and method for cooking, transporting and storing food, particularly using microwave ovens. The apparatus comprises a lower plate having a plurality of stands protruding above the surface of the plate and a grate sized to rest on the stands. The stands are of sufficient height such that when the grate is resting on the stands there is adequate space between the lower plate and grate for a plate of food to fit therebetween. A cover rests on the lower plate and is large enough to enclose the lower plate, grate and a plate of food resting on top of the grate. A vent unit is installed in the cover and located adjacent to a vent opening in the cover. The vent unit includes a closable vent door allowing the size of the vent opening to be adjustable between full open and full closed positions. This allows the user to control the amount of venting during heating. Also, after the apparatus is removed from the oven the vent may be adjusted again depending on the rate of cooling desired.

### CROSS REFERENCE TO RELATED APPLICATIONS

This patent application claims benefit of U.S. Provisional Patent Application No. 62/187,229, filed on Jun. 30, 2015. The entire content of the before-mentioned patent application is incorporated by reference as part of the disclosure of this application.

### FIELD OF INVENTION

The present invention generally relates to the field of accessories for microwave ovens. More particularly, the disclosed embodiments relate to a portable multi-level rack and enclosure assembly for use with microwave ovens.

### BACKGROUND

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Microwave ovens have made it possible to heat food more quickly and efficiently than conventional ovens. However, there exist a number of disadvantages with microwave ovens and the accessories used with them.

### BRIEF DESCRIPTION OF THE DRAWINGS

FIG. 1 illustrates a diagram of portable multilevel rack and enclosure assembly in accordance with an embodiment of the invention.

FIG. 2 illustrates a diagram of the lower plate used with the portable multilevel rack and enclosure assembly shown in FIG. 1 in accordance with an embodiment of the invention.

FIG. 3 illustrates a diagram of a rack, or grill, for the portable multilevel rack and enclosure assembly shown in FIG. 1 in accordance with an embodiment of the invention.

FIG. 4 illustrates a diagram of a lower plate, rack and cover for the portable multilevel rack and enclosure assembly shown in FIG. 1 in accordance with an embodiment of the invention.

FIG. 5 illustrates a diagram of a lower plate and rack with plates of food thereon for portable multilevel rack and enclosure assembly in accordance with an embodiment of the invention.

FIG. 6 illustrates a diagram of lower plate and cover for the portable multilevel rack and enclosure assembly shown in FIG. 5 in accordance with an embodiment of the invention.

### SUMMARY OF THE INVENTION

This section is intended to provide a summary of certain exemplary embodiments and is not intended to limit the scope of the embodiments that are disclosed in this application.

The disclosed embodiments relate to microwave oven accessories. In particular, the invention relates to an apparatus and method that enables more than one plate of food to be cooked inside an oven, such as a microwave oven, at the same time. In addition, the apparatus can be used to carry the multiple plates of food before and after cooking. This facilitates the easy transport of the multiple plates of food. In addition, because the two plates of food are separated by a grate, the food is cooked evenly since heat can flow through the grate between two plates of food. Also, because the invention includes a cover with an adjustable vent, the amount of moisture around the food during cooking can be controlled. Also, the adjustable vent allows the rate of cooling to be controlled after the food is cooked and removed from the oven.

In one embodiment of the invention, an apparatus for cooking food in an oven includes a lower plate having a plurality of stands protruding above the surface of the plate and a grate sized to rest on the stands. The stands are of sufficient height such that when the grate is resting on the stands there is adequate space between the lower plate and grate for a plate of food to fit therebetween. A cover is provided that is sized to rest on the lower plate. Also, the cover has sufficient height to enclose the lower plate, grate, and a plate of food resting on top of the grate. A vent unit in the cover located adjacent to a vent opening in the cover, wherein the vent unit includes a closable vent door allowing the size of the vent opening to be adjustable between full open and full closed positions.

In another embodiment of the invention, a method of cooking and carrying food includes the steps of placing a first plate of food on a lower plate having a plurality of stands protruding above the surface of the plate and then placing a second plate of food on a grate sized to rest on the stands, wherein the stands are of sufficient height such that when the grate is resting on the stands there is adequate space between the lower plate and grate for the first plate of food to fit therebetween. Next, a cover is placed over the lower plate, the first plate of food, the grate, and the second plate of food, wherein the cover is sized to rest on the lower plate and having a sufficient height to enclose the lower plate, the grate and the second plate of food resting on top of the grate. Then, a vent unit in the cover located adjacent to a vent opening in the cover is adjusted somewhere between full open and full closed positions to control the amount of venting during cooking. The lower plate, first and second plates of food, grate, and cover are then placed inside a microwave oven for a desired period of time.

These and other advantages and features of disclosed embodiments, together with the organization and manner of operation thereof, will become apparent from the following detailed description when taken in conjunction with the accompanying drawings.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

The disclosed embodiments relate to an apparatus and method for cooking, transporting, and storing food. The disclosed embodiments are particularly useful to facilitate cooking in microwave ovens. The apparatus comprises a lower plate having a plurality of stands protruding above the surface of the plate and a grate sized to rest on the stands. The stands are of sufficient height such that when the grate is resting on the stands there is adequate space between the lower plate and grate for a plate of food to fit therebetween. A cover rests on the lower plate and is large enough to enclose the lower plate, grate and a plate of food resting on top of the grate. A vent unit is installed in the cover and located adjacent to a vent opening in the cover. The vent unit includes a closable vent door allowing the size of the vent opening to be adjustable between full open and full closed positions. This allows the user to control the amount of venting during heating. Also, after the apparatus is removed from the oven the vent may be adjusted again depending on the rate of cooling desired.

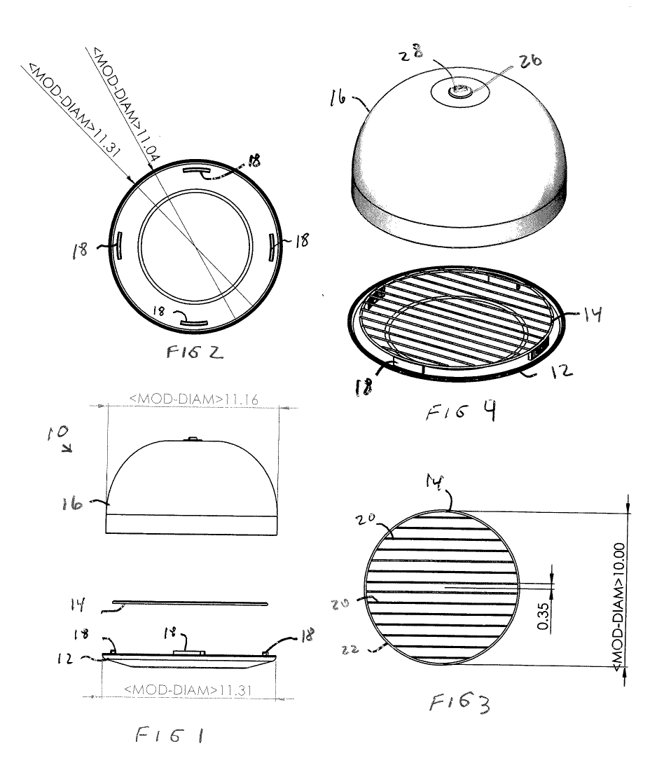

Referring now to FIG. 1, there is shown a diagram of portable multilevel rack and enclosure assembly in accordance with an embodiment of the invention. The assembly 10 includes a lower plate 12, a grill 14, and a cover 16. FIG. 2 illustrates a diagram of the lower plate 12 used with the assembly 10 shown in FIG. 1 in accordance with an embodiment of the invention. In one embodiment, the lower plate 12 is circular-shaped and may be approximately 11.31 inches in overall diameter.

The lower plate 12 includes two or more stands 18. In this embodiment there are four stands 18. The stands 18 may be permanently attached to the lower plate 12. As shown in FIG. 2, the stands 18 are arcuate-shaped to match the outer curve of the grill 14. In addition, the stands 18 may include a recess at the top surface that matches the shape of the outer ring of the grill 14. This facilitates aligning and retaining the grill 14 together with the stands 18 when the grill 14 is placed on top of the stands as shown in FIG. 3. The height of the stands 18 may be selected depending on the expected height of the plate of food to be placed on the lower plate 12. In some embodiments, the stands 18 may be 3-5 inches in height.

In another embodiment of the invention, there may a different number of stands. For example in FIG. 5 the lower plate has only two stands. The lower plate and stands are preferably made of microwavable plastic, such as polyethylene or polypropylene.

FIG. 3 illustrates a diagram of a rack, or grill, for the portable multilevel rack and enclosure assembly shown in FIG. 1 in accordance with an embodiment of the invention. The grill 14 rack is made of a rows of straight spaced-apart metal rods 20 attached to a metal rod 22 formed in the shape of a ring at the periphery. The diameter of the circular metal rod 22 matches the recess at the top of the stands 18 described below. In one embodiment, the grill 14 may have a diameter of about 10 inches.

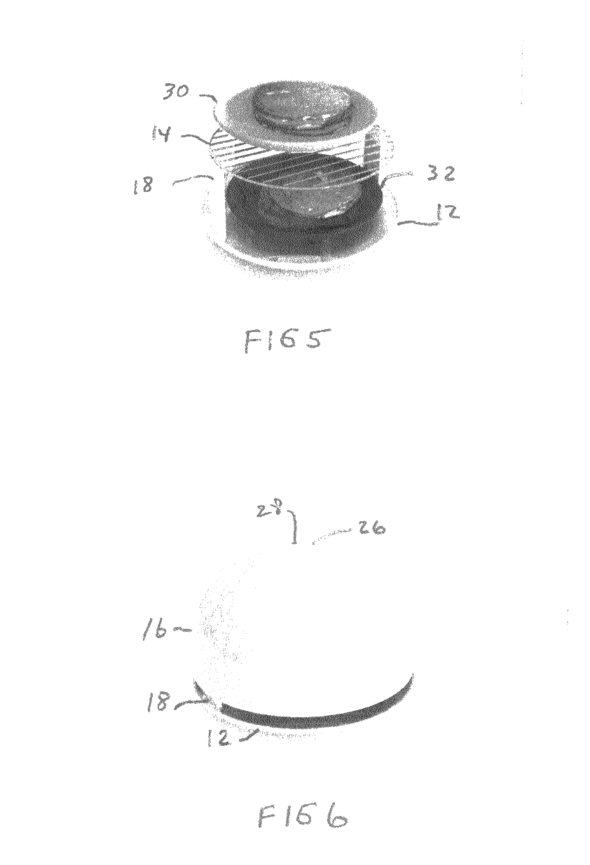

FIG. 4 illustrates a diagram of the lower plate 12, rack 14 and cover 16 for the portable multilevel rack and enclosure assembly 10 shown in FIG. 1 in accordance with an embodiment of the invention. The cover 16 is dome-shaped and preferably made of microwavable plastic, such as polyethylene or polypropylene. The cover 16 includes a vent unit 24 at the top and a cover opening (not shown). The vent unit 24 includes a rotatable disc 26 adjacent to the cover opening. The disc 26 includes an opening 28. The disc 26 is attached by a pin to the cover 16 so that the disc 26 can be rotated. By rotating the disc 26 so that the disc is over the cover opening, the user can close the cover opening. Alternatively by rotating the disc so that the opening 28 is directly over the cover opening, the cover opening can be left open. Alternatively, the disc may be rotated so that the cover opening may be partially closed.

There are many ways in which the vent unit 24 may be used. In some situations, when cooking food in a microwave oven, it may be desirable to have the vent closed, thereby retaining as much heat and moisture within the cover. In other situations, it may be desirable to have the vent unit 24 open when cooking to release excess moisture and also to prevent pressure from building up. In still other situations, it may be desirable to have the vent unit 24 partially open to achieve a compromise situation where only some of the moisture is released.

Referring now to FIG. 5, there is shown a diagram of a lower plate 12 and rack 14 with plates of food when used with the assembly 10 in accordance with an embodiment of the invention. In particular, lower plate 12 is shown with a plate of food 32 resting on it, while grill 14 is shown with a plate of food 30 resting on it. FIG. 6 illustrates a diagram of lower plate and cover for the portable multilevel rack and enclosure assembly shown in FIG. 5 in accordance with an embodiment of the invention. In particular, the lower plate 12 with a stand 18 can be seen with the cover 16 slightly above the lower plate 12.

The various embodiments of the assembly 10 can be used in many ways to achieve the numerous advantages of the invention. As shown in FIG. 5, two plates of food 30, 32 may be stacked in the assembly 10 as follows. First, one plate of food 32 is placed on the lower plate 12. Then the grill 14 is placed on the lower plate stands 18. Next, the second plate of food 30 is placed on the grill and the cover 16 is placed on to the lower plate 12. It should be noted that the plates of food 30, 32 may be placed in the assembly 10 before, or after, the assembly 10 is placed in an oven. Likewise, the cover 16 may be placed on the assembly 10 before, or after, the assembly 10 is placed in an oven. The vent 26 may be adjusted to the desired position depending on how much moisture is desired to be retained in the assembly 10. It may take trial and error for the use to determine the precise setting of the vent 26 to achieve the desired result. Because the cover 16 completely covers both plates of food, there is little chance of food splattering the inside of the microwave oven, in contrast to other designs which have numerous vents that could allow splattering food to escape.

By having two plates of food cooking at the same time the user avoids the extra effort and time required to sequentially cook one plate of food, remove that plate, insert the second plate of food, and remove the second plate. Another advantage is the energy savings by not having to heat the second plate of food separately. Also, when two plates of food are heated separately, while the second plate of food is heating the first plate of food is cooling off, resulting in one plate being cooler than the other when they are served. In some instances, the first plate of food needs to be reheated so that it is not cool when served. With the assembly 10, both plates would be generally the same temperature when served.

Another advantage is that both plates of food are in the same enclosed space so that they both will be heated up at nearly the same rate. This feature is enhanced by the use of the grill 14, which has openings in it, instead of using a solid surface. With some other designs, the two plates of food are isolated from each other, which can result in one plate of food being heated more than the other. Also, the assembly 10 is easy to use, assemble, disassemble, and clean. The stands 18, which are located near the edge of the lower plate 12, make it easy to insert the first plate of food.

Another advantage of the assembly 10 is its portability. The assembly 10 makes it easy to transport the two plates of food, both before and after the food is cooked. This facilitates, for example, transporting the food from one location to another. In one instance, the food may be cooked and then removed from the oven and transported to another location. With the vent 26 closed to retain the heat, assembly 10 will help keep the food warm during transport until it is ready to be served. The design of the assembly 10 also makes it relatively stable so that the plates of food are not likely to tip during transport. In some cases the plates of food in the assembly 10 may be stored in a refrigerator either before or after cooking.

While the assembly 10 has been described as being used with a microwave oven, it may also be employed with other kinds of ovens as long as the materials chosen are compatible with those ovens. In addition, while the assembly 10 has been shown with circular components, it will be appreciated that other shapes, such as square shapes, can be employed for the lower plate, grill and cover.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. An apparatus for cooking food in an oven comprising:
a lower plate having a plurality of stands protruding above the surface of the plate;
a grate sized to rest on the stands, wherein the stands are of sufficient height such that when the grate is resting on the stands there is adequate space between the lower plate and grate for a plate of food to fit therebetween;
a cover sized to rest on the lower plate and having a sufficient height to enclose the lower plate, grate and a plate of food resting on top of the grate; and
a vent unit in the cover located adjacent to a vent opening in the cover, wherein the vent unit includes a closable vent door allowing the size of the vent opening to be adjustable between full open and full closed positions.

2. The apparatus of claim 1 wherein the grate is a metal grate comprised of spaced apart metal rods, wherein heat can flow freely from below grate to above the grate within the interior of the cover.

3. The apparatus of claim 1 wherein the stands are permanently attached to the lower plate.

4. The apparatus of claim 1 wherein there are two stands at opposite sides of the lower plate.

5. The apparatus of claim 1 wherein the stands are removably attached to the lower plate, wherein stands of different heights may be attached to the lower plate to change the spacing between the lower plate and the grate such that food of different heights may be accommodated.

6. The apparatus of claim 1 wherein the stands have a top surface with a recess that is shaped and sized to receive the outer edge of the grill when the grill is resting on the stands.

7. The apparatus of claim 1 wherein the lower plate and grill are circular-shaped and the cover is dome-shaped.

8. The apparatus of claim 1 wherein the vent unit is located at the top of the cover.

9. The apparatus of claim 1 wherein the vent unit closable door is circular-shaped and is rotatably mounted such that the vent door is rotated to move between the full open and full closed positions.

10. The apparatus of claim 1 wherein the stands are disposed near the outer edge of the lower plate such that a plate of food can fit between the stands when resting on the lower plate.

11. The apparatus of claim 1 further comprising:
a plate of food disposed on the lower plate; and
a plate of food disposed on the grate.

12. The apparatus of claim 1 wherein the lower plate and the cover are comprised of microwaveable plastic.

13. The apparatus of claim 1 wherein the grate is comprised of metal.

14. An apparatus for enclosing food in a microwave oven comprising:
a circular lower plate having a plurality of stands protruding above the surface of the plate;
a circular grate sized to rest on the lower plate stands, wherein the stands are of sufficient height such that when the grate is resting on the stands there is adequate space between the lower plate and grate for a plate of food to fit therebetween;
a dome-shaped cover sized to rest on the lower plate and having a sufficient height to enclose the lower plate, grate and any plate of food resting on top of the grate; and
a vent unit in the cover located adjacent to a vent opening in the cover, wherein the vent unit includes a circular closable vent door allowing the size of the vent opening to be adjustable between full open and full closed positions when the vent door is rotated.

15. A method of cooking and carrying food comprising:
placing a first plate of food on a lower plate having a plurality of stands protruding above the surface of the plate;
placing a second plate of food on a grate sized to rest on the stands, wherein the stands are of sufficient height such that when the grate is resting on the stands there is adequate space between the lower plate and grate for the first plate of food to fit therebetween;
placing a cover over the lower plate, the first plate of food, the grate, and the second plate of food, wherein the cover is sized to rest on the lower plate and having a sufficient height to enclose the lower plate, the grate and the second plate of food resting on top of the grate;
adjusting a vent unit in the cover located adjacent to a vent opening in the cover, somewhere between full open and full closed positions to control the amount of venting during cooking; and
placing the lower plate, first and second plates of food, grate, and cover inside a microwave oven for a desired period of time.

16. The method of claim 15 further comprising:
removing the lower plate, first and second plates of food, grate and cover from the microwave oven after the desired period of time has elapsed; and
adjusting the vent somewhere between the full open and full closed positions depending on the desired speed of cooling of the food inside.

17. The method of claim 15 further comprising:
removing the lower plate, first and second plates of food, grate and cover from the microwave oven after the desired period of time has elapsed;
readjusting the vent to a new desired position depending on the desired speed of cooling of the food inside; and
transporting the lower plate, first and second plates of food, grate and cover to another location prior to serving the food.
